(19) United States
(12) Patent Application Publication
(10) Pub. No.: US 2008/0305243 A1
(43) Pub. Date: Dec. 11, 2008

(54) METHOD FOR IDENTIFYING ARTICLES AND PROCESS FOR MAINTAINING SECURITY

(76) Inventor: Damien F. Reardon, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/759,966

(22) Filed: Jun. 8, 2007

(51) Int. Cl. B44F 1/12

(52) U.S. Cl. 427/7; 427/157

(57) ABSTRACT

The invention is directed to a method wherein at least a portion of a luminescent coating disposed on a surface of an article is exposed to ultraviolet light causing the luminescent coating to exhibit luminescence, detecting the luminescence, causing a comparison to be made between the luminescence and a predetermined standard, and classifying the article according to the comparison, wherein the luminescent coating has a luminescent chelate being a lanthanide and a ligand, the ligand being represented by the formula

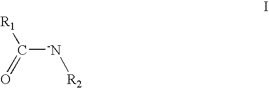

wherein R₁ is alkyl, aryl, or heteroaryl; R₂ is alkyl, aminoalkyl; aryl or heteroaryl.

### FIELD OF THE INVENTION

The present invention is directed to a method for identifying articles, for the purpose of thwarting counterfeiting, by marking the articles with a luminescent composition comprising a rare-earth chelate with amide ligands.

### BACKGROUND OF THE INVENTION

Luminescent rare-earth chelates are known. Certain rare-earth chelates will exhibit luminescence in the visible portion of the spectrum when exposed to ultraviolet light.

Rare-earth (or lanthanide) metal ions are absorbent in the ultraviolet; some luminesce in the visible, some in the infrared. It is also known in the art that when a rare-earth is complexed with certain organic ligands luminescence quantum yield of the rare-earth can be greatly enhanced by the broad band absorbance of the organic moiety in the ultraviolet spectrum which can efficiently transfer non-radiative energy to the rare-earth ion which then luminesces.

A rare-earth element when incorporated into a chelate structure exhibits a characteristic excitation spectrum and emission or luminescence spectrum. Each such spectrum consists of a plurality of peaks at different wavelengths of light. The wavelengths at which the peaks occur are characteristic of each rare-earth element. The excitation spectrum is determined by monitoring the luminescence intensity at one wavelength while the specimen is illuminated over a range of wavelengths. The luminescence spectrum is determined by illuminating the specimen at a single wavelength corresponding to a peak in the excitation spectrum and determining the luminescence spectrum by scanning a detector over a range of wavelengths. No two rare-earth elements exhibit the same excitation or emission spectra; that is, the peaks in their spectra do not in general arise at the same wavelengths. These and related matters are all well-documented in the art. See for example, Martin et al., Atomic Energy Levels—the Rare-Earth Elements, U.S. Department of Commerce, National Bureau of Standards (1978).

Mathur et al., Synth. React. Inorg. Met.-Org. Chem. 11(3), 231-244 (1981) discloses lanthanide chelates wherein the associated ligands are represented by the formula R₁NHC(O)R₂ wherein R₁ is phenyl, chloro-phenyl, or nitro-phenyl, and R₂ is methyl or phenyl with the proviso that when R₂ is phenyl, R₁ is unsubstituted phenyl. The lanthanide chelates disclosed therein were employed for infrared spectroscopic studies.

Many types of ligands are known in the art for use in forming chelates with rare-earth metals, and, even more generally, with transition metals. There is a continuing need to develop methods to use such rare-earth chelates that luminesce.

### SUMMARY OF THE INVENTION

The present invention is directed to a method comprising exposing at least a portion of a luminescent coating disposed on a surface of an article to ultraviolet light causing the luminescent coating to exhibit luminescence, detecting the luminescence, causing a comparison to be made between the luminescence and a predetermined standard, and classifying the article according to the comparison, wherein the luminescent coating comprises a luminescent chelate comprising a

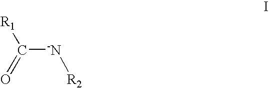

lanthanide and a ligand, the ligand being represented by the formula wherein R₁ is alkyl, aryl, or heteroaryl; R₂ is alkyl, aminoalkyl; aryl or heteroaryl.

Further provided is a method comprising within a first time period, disposing upon at least a portion of a surface of a first article a first luminescent coating wherein the first luminescent coating comprises a first luminescent chelate comprising a lanthanide and a ligand, the ligand being represented by the formula

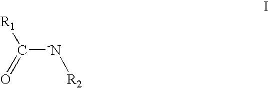

wherein R₁ is alkyl, aryl, or heteroaryl; R₂ is alkyl, aminoalkyl; aryl or heteroaryl; optionally, drying the coating; and, exposing the first coating to a first preselected wavelength of light wherein the first luminescent chelate exhibits a first luminescence spectrum having a first plurality of intensity peaks.

Still further provided is the method comprising within a second time period, disposing upon at least a portion of the surface of a second article a second luminescent coating wherein the second coating comprises a second luminescent chelate comprising a lanthanide and a ligand, the ligand being represented by the formula

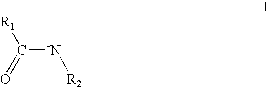

wherein R₁ is alkyl, aryl, or heteroaryl; R₂ is alkyl, aminoalkyl; aryl or heteroaryl; optionally, drying the second coating; and, exposing the second coating to a second preselected wavelength of light wherein the second luminescent chelate exhibits a second luminescence spectrum having a second plurality of intensity peaks with the proviso that the first luminescent chelate is different from the second luminescent chelate.

The method further comprises comparing the first plurality of intensity peaks to a first standard, and comparing the second plurality of intensity peaks to a second standard, this may be done independently and classifying the article according to whether or not the peak intensity ratio does or does not match the standard.

### DETAILED DESCRIPTION

The term “ligand” as found herein refers to an organic amide compound that can bond to a lanthanide metal by overlap of an empty orbital on the metal with a filled orbital on the ligand. The bonded anionic ligand is called the amidate. The “amide” is the neutral protonated ligand and the “amidate” is its anionic counterpart which has been deprotonated and bears a delocalized negative charge through its resonance structure, as indicated by the structures:

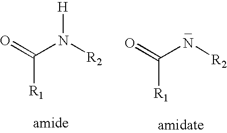

The structure represented by structure (I) is thought in the art to be resonant structures, as indicated by the following equilibrium reaction:

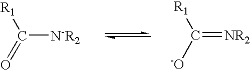

Throughout the present invention, structure (I) will be employed to represent both resonant structures.

The term “chelate” means an inorganic complex formed between a lanthanide metal and a ligand that has a plurality of binding sites and wherein the ligand is bound to the metal at two or more of the binding sites of the ligand.

The term “classifying” refers to some action undertaken to segregate the coated articles that match the standard from those that do not. Classification can involve sorting into separate boxes, bins, and the like, or could involve simply placing a further marking of some sort on the article to indicate conformity or non-conformity with the standard. In another embodiment classification may simply be a list that can be kept by hand or on a computer memory. The term “classifier” refers to any agent that can determine whether or not the measured peak intensity ration corresponds to the standard, and can cause the act of classification to occur. The classifier may be a human being, but need not be. The classifier can be a robot or other device that performs the necessary functions.

As the present invention is employed, the manufacturer or distributor of an article acts as the “coater” causing the surface of an article to be marked according to the methods herein disclosed in order to provide positive identification or confirmation of the authenticity of the article so marked. In the sense employed herein, the term “coater” may comprise one or more human beings, corporate entities, and/or robotic devices. The “coater” may refer both to the corporate entity and to a plurality of human beings (for example, shift workers) under the auspices of which corporate entity physically apply the luminescent coating to the surface of the article. “Coater” encompasses the means by which the coating is applied, as well as the means by which the standard is determined. According to the present invention, it is the coater that determines the luminescence standard, and communicates that standard to the “classifier.”

The standard can include information regarding a preselected exposure wavelength and a plurality of preselected luminescence wavelength peaks, and the peak intensity ratio thereof. This information is communicated from the “coater” to the “classifier” so that the classifier is able to distinguish conforming (authentic) from non-conforming (counterfeit) articles. The standard need not be sophisticated: it could simply be a particular color or shade of luminescence.

In an embodiment, the coated article is transferred, by shipping, to a recipient, typically a customer or a jobber. The recipient then performs the classification by making inquiry of the coated article employing a light source that emits at the preselected wavelengths, and a detector that enables determination of peak intensity ratio of the selected luminescence peaks.

The present invention provides a method comprising exposing at least a portion of a luminescent coating disposed on a surface of an article to ultraviolet light causing the luminescent coating to exhibit luminescence, detecting the luminescence, causing a comparison to be made between the luminescence and a predetermined standard, and classifying the article according to the comparison, wherein the luminescent coating comprises a lanthanide and a ligand that together

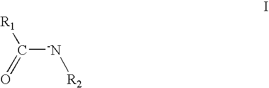

form a chelate structure, the ligand being represented by the formula wherein R₁ is alkyl, aryl or heteroaryl, R₂ is alkyl, aminoalkenyl; aryl or heteroaryl.

In one embodiment, the present invention provides a method comprising exposing at least a portion of a luminescent coated surface of an article having a surface to ultraviolet light at one or more preselected wavelengths thereby causing the coating to luminesce. The luminescence spectrum of the coating exhibits a plurality of intensity peaks that have been priorly determined using light comprising the preselected wavelength or wavelengths to create a standard. Authenticity of the article is ascertained by comparing the peak intensity ratio of at least two peaks in the luminescence spectrum of the coating with the peak intensity ratio of the standard. The article is then classified according to whether or not the peak intensity ratio of the luminescent coating on the article does or does not match that of the standard. The luminescent coating comprises a a lanthanide and a ligand that together form a chelate structure, the ligand being represented by the formula

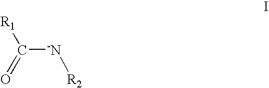

wherein R₁ is alkyl, aryl or heteroaryl, R₂ is alkyl, aminoalkenyl; aryl or heteroaryl.

In order to provide enhanced security, the coater employs in a first period of time a first luminescent coating with which to mark the manufactured articles, and during a second period of time, employs a second luminescent coating, different from the first luminescent coating. In such case, the coater informs the classifier of the change from the first standard to the second standard. Both the luminescent coatings comprise a lanthanide and a ligand that together form a chelate structure, the ligand being represented by the formula

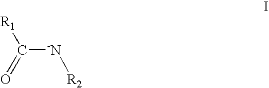

wherein R₁ is alkyl, aryl or heteroaryl, R₂ is alkyl, aminoalkenyl; aryl or heteroaryl.

The present invention allows for there to be compositions comprising more than one ligand in a single chelate, a mixture of lanthanide chelates. While the compositions useful in the present invention comprise chelates of a lanthanide and an amide ligand, additional ligands that are not amides may also be present.

The manner in which the coating is applied is not germane to the operability of the invention. Any convenient means is suitable including printing, painting, spray coating, dip coating, and the like. Printing can include any type of printing including screen printing and ink jet printing The coating compositions employed in the method hereof exhibit unusual thermal stability making them well-suited for a wide range of processing, handling, and use temperatures including use conditions in which the coated article is subject to temperatures of about 150° C. for prolonged periods.

Ink jet printing is one method for applying the coating to the surface of the article. A suitable ink is formulated by combining the luminescent chelate and a liquid carrier preferably including as well a binder polymer. The luminescent chelate may be dissolved or dispersed in the carrier liquid, as may also be the polymer. Methods routinely employed in the art for preparation of dispersions using insoluble pigments may be employed to produce coating compositions according to the present invention.

Any lanthanide except promethium and lutetium is satisfactory. Suitable lanthanides are in the +3 valence states. Preferred lanthanides are those that luminesce in the visible portion of the electromagnetic spectrum, including europium, dysprosium, samarium, terbium.

Suitable aryls include but are not limited to phenyl, napthyl, anthracyl, or phenanthrenyl. Suitable heteroaryls include but are not limited to pyridinyl, quinolinyl, thionyl, furanyl, pyrollyl, oxazollyl, imidazollyl, pyrimidinyl, purinyl, nucleosides or keto tautomers of their enol forms. Suitable aryls or heteroaryls include substituted aryls or heteroaryls. All aromatic compositions described herein may be substituted or unsubstituted. Examples of substituents include but are not limited to the radicals such as alkyl, aryl, halo, alkoxy, halogenated alkyl, sulfanyl, secondary amino, or nitro.

Suitable aminoalkyl groups are represented by the formula

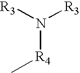

wherein each R₃ can independently be C1-C8 alkyl, preferably C1-C3, and R₄ can be C1-C8 alkenyl, preferably C2-C4. Most preferably, R₃ is methyl, and R₄ is ethenyl.

Suitable ligands include but are not limited to those represented by the formulae following, wherein Q can be O or S. Further, any six ring aryl structure can be replaced by a pyridinyl ring. Any of the aromatic rings can also have substituents including but not limited to alkyl, aryl, halo, alkoxy, halogenated alkyl, sulfanyl, secondary amino, or nitro.

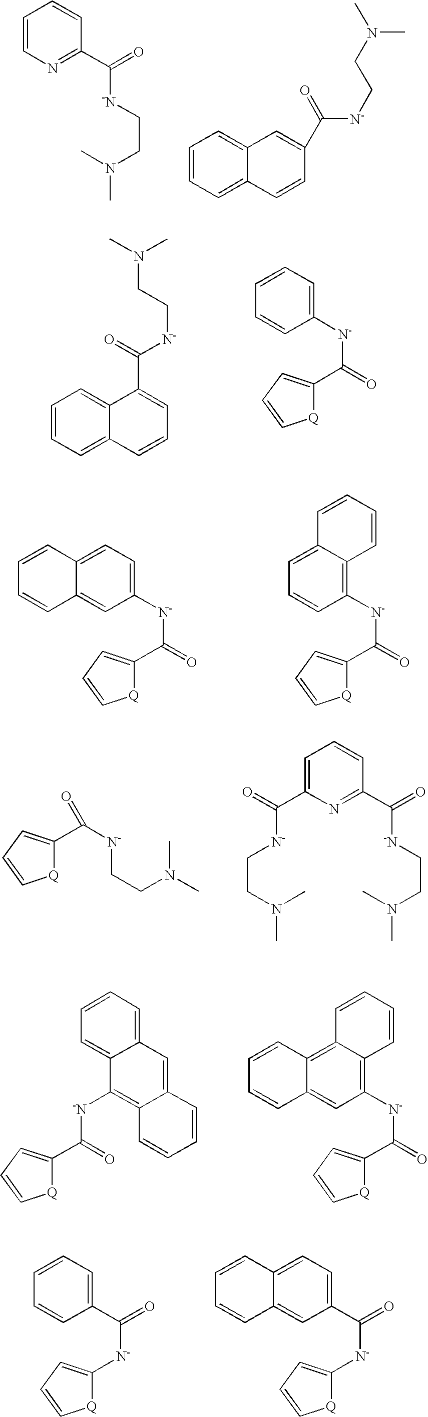

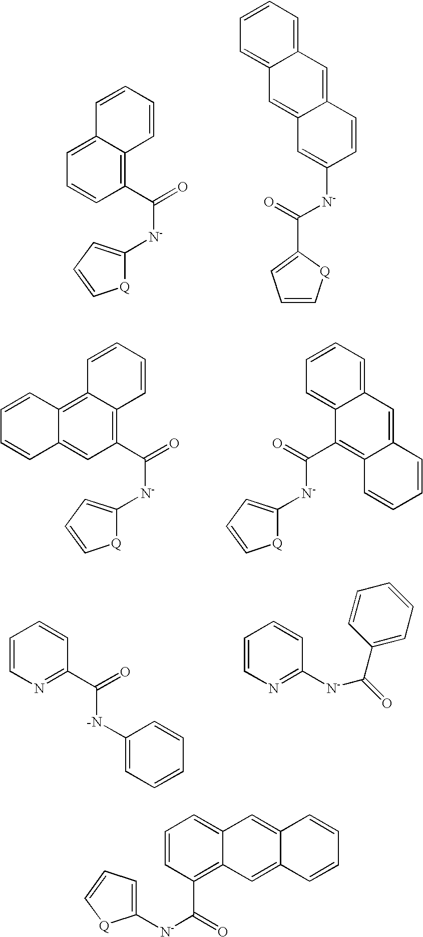

Also included are ligands having multiple heteroatoms in the aryl ring. For example pyrimidine, thiazole, oxazole, pyrrole, oxazole, imidazole, pyrimidine, purine, nucleosides or keto tautomers of their enol forms may be substituted for any of the aryl rings.

Particular combinations of R₁ and R₂ in the anionic amidate ligand are recited in Table 1.

TABLE 1

| R₁ | R₂ |
|---|---|
| Heteroaromatic ring | Aromatic ring |
| Heteroaromatic ring | Dialkylaminoethyl group |
| Aromatic ring | Dialkylaminoethyl group |
| Aromatic ring | Aromatic ring |
| Aromatic ring | Heteroaromatic ring |

Preferably the heteroaryl ring is thiophenyl, pyridinyl or furanyl. Preferably the aryl ring is phenyl, naphthyl, anthracyl, or phenanthranyl. Preferably, the dialkylaminoalkyl group is dialkylaminoethyl. More preferably the dialkylaminoethyl is dimethylaminoethyl.

Also included in the composition of the present invention are lanthanide amidate complexes in combination with coordinating ligands including but not limited to heteroaryl rings, substituted or unsubstituted, such as pyridine, pyridine-N-oxide, thiophene, furane, ketones, 1,10-phenathroline, tri-substituted phosphine oxides and di-substituted ethylene bridged di-phosphine oxides. Suitable coordinating neutrally charged ligands are represented in the following structures:

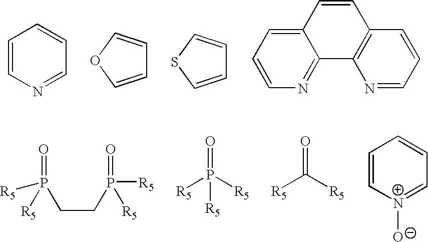

wherein each R₅ can independently be aryl or C1-C6 alkyl.

Coordination of these neutral ligands to the tris amidato lanthanide in the mole ratio range of 1:1 or 1:2 will yield the following representative structures:

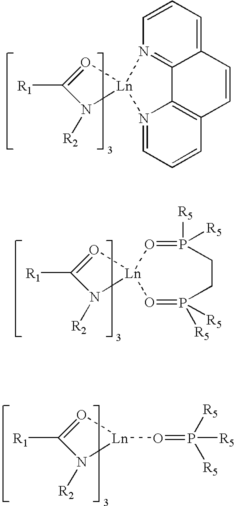

wherein R₁ is alkyl, aryl, or heteroaryl; R₂ is alkyl, aminoalkyl; aryl or heteroaryl, and each R₅ can independently be aryl or C1-C6 alkyl.

Suitable carriers include but are not limited to water, alkanes such as hexane; alcohols; aldehydes; ketones; ethers, such as dipropylene glycol monomethyl ether; esters, such as ethyl acetate, propyl acetate, or dipropylene glycol monomethyl ether acetate; nitrites, amides, aromatics such as toluene; and mixtures thereof. Water and alcohols are preferred. Methanol, ethanol, propanols, butanols, or mixtures thereof are highly suitable. Water and a mixture of alcohol and water are also highly suitable. Preferred carrier liquids include acetone, methyl-ethyl ketone, methanol, ethanol, propanol, butanol, 1,2-ethanediol, 1,2-propanediol, 1,3-propanediol, 2-methoxypropanol, 2-methoxyethanol, 3-methoxypropanol, ethylene glycol dimethyl ether, ethylacetate, toluene and water. Other useful liquids include terpineol, toluene, xylene, dimethylformamide, pyridine, ethylbenzene, carbon disulfide, 1-nitropropane, and tributylphosphate.

Useful polymers for systems in which the carrier liquid is aqueous include, but are not limited to poly (ethylene oxide), poly(acrylamide), poly(vinylpyrrolidone), poly(vinyl alcohol) and poly(vinyl acetate). Included in each of these terms are both homo- and copolymers of the primary monomers, as well as mixtures thereof.

Useful polymers for use in carrier liquids based upon non-aqueous solvents include, but are not limited to cellulosic polymers, poly(alpha-olefins) where the olefins contain six or more carbon atoms when used in conjunction with non-polar solvents such as alkanes; acrylic polymers when used in conjunction with polar organic solvents such as esters, ketones, and glycol- and other ethers. Esters include but are not limited to ethyl acetate, butyl acetate, butyl cellosolve acetate; carbitol esters; ketones include but are not limited to acetone, methylethylketone, diisopropylketone, and cyclohexanone. Ethers include but are not limited to tetrahydrofuran, dioxane, tetrahydrofurfural alcohol.

Mixtures of polymers are also suitable. Mixtures of polymers often provide a more desirable combination of properties than can be obtained from a single polymer.

One fundamental requirement for the polymer employed herein is that the polymer can not exhibit significant absorbance at either the excitation or emission wavelengths of interest because of interference with the intensity of the observed luminescence.

Numerous chemical formulations are known in the art for preparing inks, paints, and other coating compositions. Every such composition in the art that contains inorganic pigments in particulate form can be employed to formulate an ink, paint, or other coating composition with the luminescent chelate described supra serving as the pigment. The luminescent chelate may serve as the only pigment, or it may be combined with other pigments and particulate matter such as is known in the art of inks and coatings.

In one embodiment, the luminescent coating comprises a lanthanide chelate represented by the structure

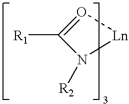

wherein Ln is Eu³⁺, Tb⁺³, Sm⁺³, or Dy⁺³; R₁ is selected from the group consisting of phenyl, naphthyl, thiophenyl, furanyl, pyridyl, C1 to C6 alkyl, anthrancenyl, and phenanthracenyl; and R₂ is selected from the group consisting of phenyl, naphthyl, pyridyl, C1 to C6 alkyl, anthrancenyl, and phenanthracenyl, and dimethylaminoethyl. In one embodiment, Ln is Eu³⁺ or Tb³⁺. In one embodiment R₁ is thiophenyl or naphthyl. In one embodiment, R₂ is dimethylaminoethyl.

In an alternative embodiment, the coating comprises a lanthanide chelate coordination compound represented by the structure

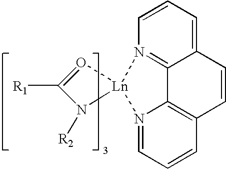

wherein Ln is Eu³⁺, Tb⁺³, Sm⁺³, or Dy⁺³; R₁ is selected from the group consisting of phenyl, naphthyl, thiophenyl, furanyl, pyridyl, C1 to C6 alkyl, anthrancenyl, and phenanthracenyl; and R₂ is selected from the group consisting of phenyl, naphthyl, pyridyl, C1 to C6 alkyl, anthrancenyl, and phenanthracenyl, and dimethylaminoethyl. In one embodiment, In one embodiment, Ln is Eu³⁺ or Tb³⁺. In one embodiment R₁ is thiophenyl or naphthyl. In one embodiment, R₂ is dimethylaminoethyl.

In an alternative embodiment, the coating comprises a lanthanide chelate coordination compound represented by the structure

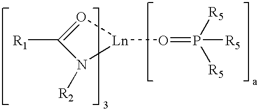

wherein a=1 or 2, Ln is Eu³⁺, Tb⁺³, Sm⁺³, or Dy⁺³; R₁ is selected from the group consisting of phenyl, naphthyl, thiophenyl, furanyl, pyridyl, C1 to C6 alkyl, anthrancenyl, and phenanthracenyl; and R₂ is selected from the group consisting of phenyl, naphthyl, pyridyl, C1 to C6 alkyl, anthrancenyl, and phenanthracenyl, and dimethylaminoethyl, and R₅ is aryl or C1 to C6 alkyl. In one embodiment, a=2. In one embodiment, Ln is Eu³⁺ or Tb³⁺. In one embodiment R₁ is thiophenyl or naphthyl. In one embodiment, R₂ is dimethylaminoethyl. In one embodiment, R₅ is phenyl.

Additional ingredients such as electrolytes, humectants, and other additives such as are commonly incorporated into ink and other coating formulations also can be present without substantively altering the operability of the invention.

The coating compositions of the present invention to be useful exhibit a desirable balance among viscosity, solubility, compatibility of components, and wettability of the substrate. Electrostatic ink deposition methods require that resistivity and polarizability also be considered. Further, coatings of the present invention, especially inks, are quick-drying and smear resistant, and resist abrasion.

In a useful ink composition, the carrier liquid is used in an amount of from about 15% by weight to about 90% by weight, preferably in an amount of from about 30% by weight to about 60% weight of the composition. In a further embodiment, polymer is employed in an amount of from 0% to about 15% by weight of the ink composition, preferably, about 2% to about 10%. Excessive amount of the polymer can adversely affect the viscosity of the ink composition.

For some printing methods, such as xerography and ink jet, electrical resistivity can be an important property. In those applications, the ink can further comprise an electrolyte to obtain the desired electrical resistivity of the jet ink composition. Any suitable electrolyte known to those of ordinary skill in the art can be used. Suitable electrolytes include but are not limited to alkali and alkaline earth metal salts such as lithium nitrate, lithium chloride, lithium thiocyanate, sodium chloride, potassium chloride, potassium bromide, calcium chloride, and the like, and amine salts such as ammonium nitrate, ammonium chloride, dimethylamine hydrochloride, hydroxylamine hydrochloride, and the like. It is important that the electrolyte salt not interfere with the luminescence.

The electrolyte is preferably present in the ink composition in the range of from about 0.1% to about 2%, more preferably 0.4% to 0.6%, by weight of the ink composition.

The ink can further comprise a pH adjusting agent if needed to enhance the dissolution of the binder resin, or improve compatibility with the surface. The desired pH will be dependent upon the particular solvent used and also to some extent upon the other components employed. Any suitable pH adjusting agent, acid or base, can be used so as to maintain the pH of the ink composition in the range of from about 4.0 to about 8.0, preferably in the range of from about 4.5 to about 7.5.

The ink can further comprise a humectant when the liquid is water in order to prevent drying of the ink during the printing operation, as well as during storage of the ink. Humectants are hydrophilic solvents preferably having boiling points in the range of from about 150° C. to about 250° C. Any suitable humectant known to those of ordinary skill in the art can be used. Examples of suitable humectants include glycols such as ethylene glycol, propylene glycol, glycerin, diglycerin, diethylene glycol, and the like, glycol ethers such as ethylene glycol dimethyl ether, ethylene glycol diethylether, cellosolve, diethylene glycol monoethylether (Carbitol), diethylene glycol dimethylether, and diethylene glycol diethylether, dialkylsulfoxides such as dimethylsulfoxide, and other solvents such as sulfolane, N-methylpyrrolidinone, and the like. Preferred humectants include propylene glycol and diethyleneglycol monoethylether.

Any suitable amount of the humectant can be used, preferably in an amount of from about 0.5% by weight to about 5% by weight of the ink composition, and more preferably in the amount of from about 1% by weight to about 3% by weight of the ink composition. Excessive use of the humectant is to be avoided because it will increase the toxicity and/or the viscosity of the ink.

The ink composition can further comprise a suitable biocide to prevent growth of bacteria, mold or fungus. Any suitable biocide can be used. DOWICIL™ 150, 200, and 75, benzoate salts, sorbate salts, and the like, methyl p-hydroxybenzoate, and 6-acetoxy-2,2-dimethyl-1,3-dioxane are examples of suitable biocides. The biocide can be present in the ink of the instant invention in the range of from about 0.05% by weight to about 0.5% by weight, preferably in the amount of from about 0.1% by weight of to about 0.3% by weight of the jet ink composition.

The ink composition can further comprise a defoamer to prevent foaming of the ink during its preparation, as well as during the printing operation. Any suitable defoamer known to those of ordinary skill in the art can be used, preferably those that are miscible with the liquid. Suitable defoamers include silicone defoamers and acetylenic defoamers. The amount used is preferably in the range of from about 0.01% by weight to about 1% by weight of the ink composition, and more preferably in the range of from about 0.05% by weight to about 0.35% by weight of the ink composition. The weight percentages given above refer to that of the active ingredient, and if the defoamer is sold in a diluted form, the amount of the diluted defoamer used will be proportionately increased. Excessive use of the defoamers is to be avoided because it can adversely affect the print quality such as adhesion to the coated substrate.

The ink composition can be printed on any suitable substrate including papers, including coated papers, plastics, leather goods, fabrics, polymeric films, glass, ceramics, metals, and so forth.

To prepare an ink suitable for use, the luminescent chelate can be dispersed in the carrier liquid using a media mill, sand mill, high speed disperser, mulling plates or other means known in the art. The dispersion so produced should contain 10%-70% by weight, preferably 40%-60% by weight, of the luminescent chelate. A dispersing aid can be added equal to ½ to 1/10, preferably ¼ to ⅕, the weight of the particles, and the remainder should be the liquid carrier or mixture of suitable liquids. Milling or mulling, dispersion and comminution may occur simultaneously.

In other ink formulations, the luminescent chelate is simply dissolved in a suitable solvent, as recited supra, at solids concentrations of 10%-70% by weight, preferably 40%-60% by weight of the luminescent chelate.

In general, a preferred ink formulation is prepared by combining a liquid carrier, a polymeric binder soluble therein, and the luminescent chelate so that the resulting composition contains 10-70% by weight, preferably 40-60%, of the luminescent chelate, 0-15% by weight, preferably 2-10%, of polymer preferably dissolved in the solvent, and 15-90%, preferably 30-60% by weight of the carrier liquid. Optionally the composition can contain plasticizer of 0 to 5% and dispersant of 0 to 8%.

The ingredients can be combined in any order. The polymer can first be dissolved in the solvent followed by addition of the particulate material which is then dispersed or dissolved therein; the particulate material so added can be in the form of dry particles or a pre-prepared particle dispersion or solution. Alternatively, the particle dispersion or solution can be prepared first followed by addition of the polymer.

Varnishes may be formulated by adapting conventional methods known in the art. In a typical formulation, the particulate luminescent compound is combined in a viscous polymer solution consisting of ca. 10% of a fugitive solvent. Varnishes are conventionally applied by brushing, rolling, and spraying.

In order to prepare the chelates suitable for the practice of the invention, a saturated aliphatic lanthanide carboxylate or a saturated aliphatic lanthanide fluorocarboxylate having 1 to 8 carbons, preferably 1 to 6, most preferably 1 to 3 carbons, is combined in a solvent with a compound represented by the formula

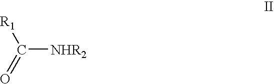

wherein R₁ is alkyl, aryl, or heteroaryl; and R₂ is alkyl, aminoalkyl; aryl or heteroaryl. Typically, the ingredients are mixed for a length of time necessary to achieve a desired amount of lanthanide amidate product.

A lanthanide fluorocarboxylate is preferred. More preferred is a lanthanide trifluoroacetate. Any lanthanide except promethium and lutetium is satisfactory for use in the process. Preferred lanthanides are those that luminesce in the visible portion of the electromagnetic spectrum, including europium, dysprosium, samarium, and terbium. The lanthanides suitable for use in the process are in the +3 valence states. Preferred are Eu(CF₃COO)₃, Dy(CF₃COO)₃, Sm(CF₃COO)₃ and Tb(CF₃COO)₃.

Suitable solvents are linear or cyclic alkanes, and aromatic hydrocarbons, both halogenated and non-halogenated. Preferred is dichloromethane.

Suitable aryls for use in R₁ or R₂ include but are not limited to phenyl, napthyl, anthracyl, or phenanthrenyl. Suitable heteroaryls include but are not limited to pyridinyl, quinolinyl, thionyl, furanyl, pyrollyl, oxazollyl, imidazollyl, pyrimidinyl, purinyl, nucleosides or keto tautomers of their enol forms. Suitable aryls or heteroaryls include substituted aryls or heteroaryls. Suitable substituents include but are not limited to the radicals such as alkyl, aryl, halo, alkoxy, halogenated alkyl, sulfanyl, secondary amino, or nitro.

Suitable aminoalkyl groups are represented by the formula

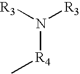

where each R₃ can independently be C1-C8 alkyl, preferably C1-C3, and R₄ can be C1-C8 alkenyl, preferably C2-C4. Most preferably, R₃ is methyl, and R₄ is ethenyl.

Suitable examples of compound (II) include but are not limited to compounds of the following formulae, wherein Q can be O or S. Further, any six ring aryl structure can be replaced by a pyridinyl ring. Any of the aromatic rings can also have substituents including but not limited to alkyl, aryl, halo, alkoxy, halogenated alkyl, sulfanyl, secondary amino, or nitro.

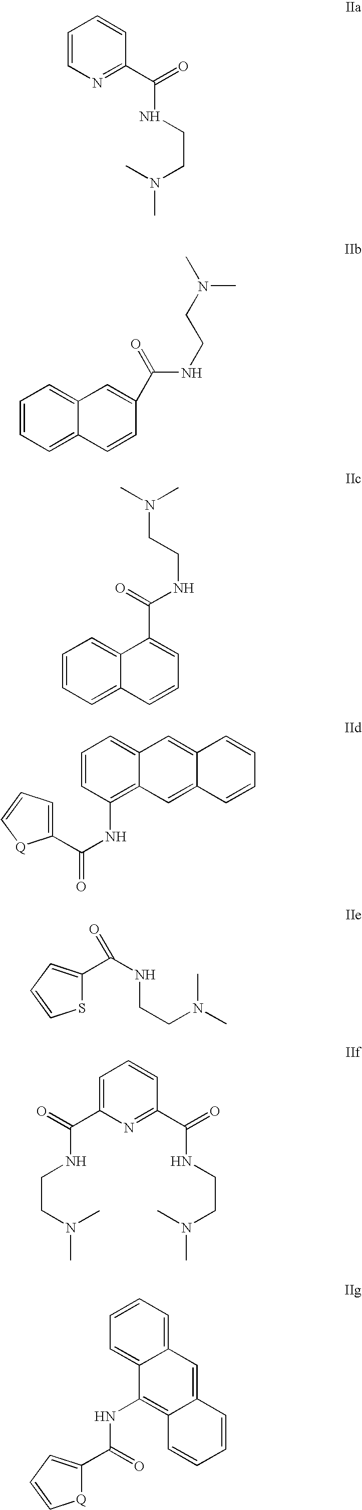

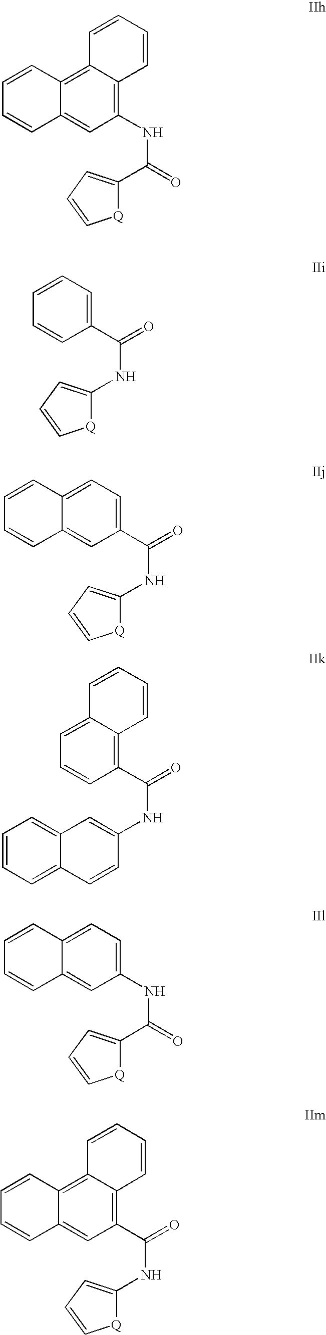

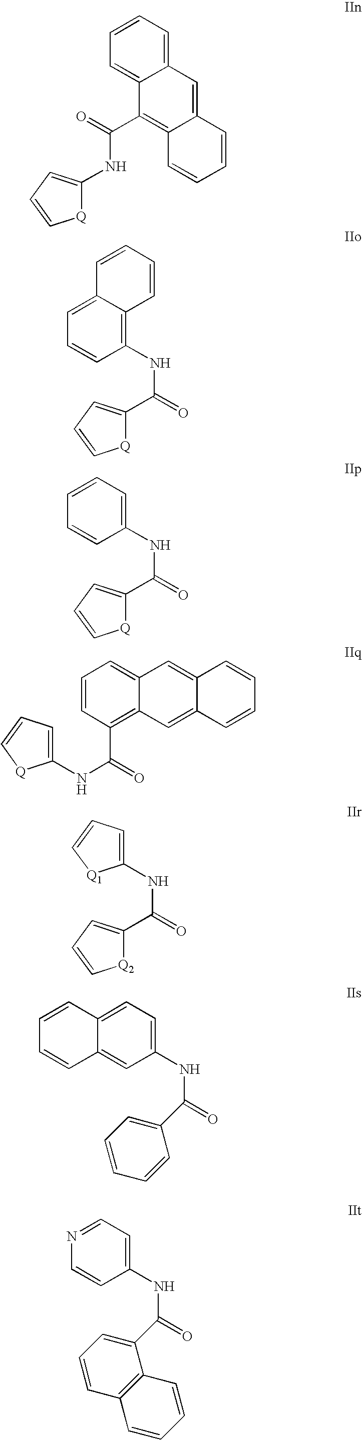

Also included are ligands having multiple heteroatoms in the aryl ring. For example pyrimidine, thiazole, oxazole, pyrrole, oxazole, imidazole, pyrimidine, purine, nucleosides or keto tautomers of their enol forms may be substituted for any of the aryl rings,

Some combinations of R₁ and R₂ in the anionic amide ligand according to the process are recited in Table 1, supra. Any of the aromatic rings in the compositions of Table 1 can also have substituents including but not limited to alkyl, aryl, halo, alkoxy, halogenated alkyl, sulfanyl, secondary amino, or nitro.

Preferably the heteroaryl ring is thiophenyl, pyridinyl or furanyl. Preferably the aryl ring is phenyl, naphthyl, anthracyl, phenanthranyl. Preferably, the dialkylaminoethyl group is dimethylaminoethenyl.

Suitable compounds (II) are known in the art, and can be prepared according to the methods of the art. For example, compound (IIl) where Q is sulfur can be prepared according to the method of Buu-Hoi et al., Recueil des Travaux Chimiques des Pays-Bas et de la Belgique (1949) 68, 5-33. Compound (IIs) can be prepared according to the method of Yabunouchi et al., WO2006073059. Compound (IIk) can be prepared according to the method of Beckmann et al., Berichte der Deutschen Chemischen Gesellschaft [Abteilung] B: (1923), 56B, 341-354. Compound (IIc) can be prepared according to the method of Giannini et al., Farmaco, Edizione Scientifica (1973), 28(6), 429-447. Compound (IIf) can be prepared according to the method of Davies et al., J. Organometallic Chem. (1998), 550(1-2), 29-57.

It has been found satisfactory to react the reactants at room temperature. However, it is anticipated that higher temperatures will accelerate the reaction. In general the maximum temperature of reaction will be limited by the boiling point of a suitable solvent. In general, it is found satisfactory to combine reactants at concentrations in a 3:1 mole ratio of the amide ligand to the lanthanide starting precursor with the exception of ligand IIF where the reaction occurred in a 2:1 mole ratio of amide ligand to the lanthanide precursor. The generic structure of the aforementioned structures is described below:

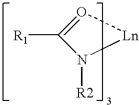

wherein Ln designates lanthanide, R₁ is alkyl, aryl, or heteroaryl; R₂ is alkyl, aminoalkyl, aryl or heteroaryl.

A neutral coordinating ligand can further be added to a solution of the tris-amidato-lanthanide chelate (III) formed as described supra. Suitable coordinating ligands include but are not limited to heteroaryl rings such as pyridine, pyridine-N-oxide, thiophene, furane, ketones, 1,10-phenathroline, tri-substituted phosphine oxides and di-substituted ethylene bridged diphosphine oxides as represented in the following structures, which can have substituents including but not limited to including but not limited to alkyl, aryl, halo, alkoxy, halogenated alkyl, sulfanyl, secondary amino, or nitro:

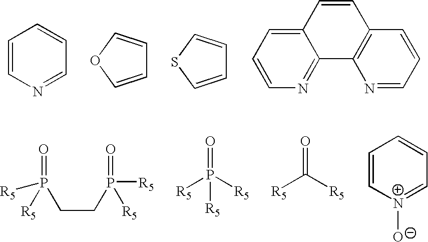

Coordination of these neutral ligands to the tris amidato lanthanide in the mole ratio range of 1:1 or 1:2 will yield the following representative structures:

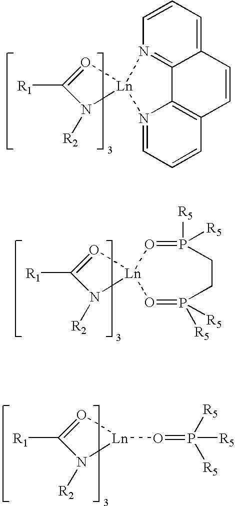

wherein R₁ is alkyl, aryl, or heteroaryl; R₂ is alkyl, aminoalkyl; aryl or heteroaryl, and each R₅ can independently be aryl or C1-C6 alkyl.

The articles comprise any coatable surface, preferably any printable surface. Suitable coatable surfaces include but are not limited to metallic surfaces, such as automobile body parts, coins, and paneling, and the like; ceramic surfaces, including glazed surfaces; glass; stone such as marble; molded plastic and fiberglass as in electronics housings and circuit boards, molded sheeting, and polymeric films and the like; leather goods; fabrics; including textile goods, and canvas, and the like; papers, including coated papers, including currencies, bonds, and other securities, and contracts and the like.

Any method of printing may be employed including gravure printing, off-set printing, lithography, screen-printing, ink-jet printing, xerography, and so forth.

According to the present invention, a method is provided wherein the luminescent coating on the surface of the coated article is subject to UV illumination at one or more pre-selected wavelengths and stimulated thereby to luminesce. In the broadest terms, the resulting luminescence may be detected by any convenient means that permits classification by comparison to a standard, including visual inspection.

In a preferred method, the luminescence spectrum emitted by the coated article employed in the method hereof is characterized by a series of peaks of varying intensity at specific wavelengths. In a preferred method of classification, the ratio of pre-selected intensity peaks is determined and compared to the standard described supra. Depending upon whether it is determined to match or not match the standard, the coated article is subject to being classified as authentic or inauthentic, respectively.

The specific instrumentation by which the illumination is provided and the relative intensity of the pre-selected luminescence peaks is determined is not critical to the operability of the invention. One method, as described in the specific embodiments infra is to employ well-known laboratory phorphorimeters, spectrometers, in conjunction with laser light sources, filtered broad band sources, and other sources of illumination well-known in the art of spectroscopy.

Alternatively, an electro-optical reader can be employed for reading an identifying mark as herein described, which comprises a source of light directed towards the mark to illuminate at least a portion of it, a photo-detector means for detecting the luminescence obtained from the illuminated portion of the mark, and a determining means connected with the photo-detector for comparing an output from the photo-detector with a reference signal stored therein to verify the authenticity of the mark. One instrument satisfactory for use in the method of the present invention is the electro-optical reader in Inaba et al., U.S. Pat. No. 6,981,648.

A suitable such electro-optical reader comprises a UV laser oscillator or light emitting diode the light from which is shaped into a fine pencil by a condensing lens. The pencil of laser light emerging from the optical illumination system is directed to the surface of the coating herein described. The luminescence stimulated thereby passes to a photo-detector in the electro optical reader after having passed through a plurality of optical filters operable to permit passage therethrough of only light of the predetermined wavelengths of the luminescence intensity peaks of interest. The photo-detector can be a photodiode, an avalanche photodiode or any other high sensitivity photo-detector. An output signal from the photo-detector array contains the intensity data of the pre-selected intensity peaks. The photodetector signals can be amplified and conditioned as necessary, and the signals are combined to provide the intensity ratios thereof. The resulting ratio is then supplied to a determining circuit which includes a memory in which the standard as described supra. The determining circuit can be electrically connected with a display unit allowing the result to be visually indicated.

In a further embodiment, the present invention provides a method comprising, within a first time period, a coater causing to be disposed upon the surface of a first plurality of articles, a first luminescent coating, thereby producing a first plurality of coated articles; and, within a second time period, the coater causing to be disposed upon the surface of a second plurality of articles, a second luminescent coating, thereby producing a second plurality of coated articles; a classifier causing to be exposed at least a portion of one or more of the first or second plurality of coated articles to ultraviolet light at one or more preselected wavelengths thereby causing the coating to exhibit, respectively a first or second luminescence spectrum, each the first or second luminescence spectrum exhibiting a plurality of intensity peaks the wavelengths of the peaks having been priorly determined using light comprising the preselected wavelength or wavelengths to create a first standard corresponding to the first plurality of coated articles and a second standard corresponding to the second plurality of coated articles; determining the peak intensity ratio of at least two the intensity peaks in the first or second luminescence spectrum of the first or second coating; comparing the peak intensity ratio so determined with, respectively, the first or second standard depending upon whether the coated article is from the first or second plurality of coated articles; and, classifying the article according to whether or not the peak intensity ratio does or does not match the first or second standard, respectively; each the coating comprising a luminescent chelate dispersed therein.

The method of the present invention provides a means for a first party, the “coater,” to provide a luminescent identifying mark comprising the luminescent chelate composition described supra on a plurality of objects, and for a second party, “the classifier,” to compare the luminescence of the identifying mark on objects received by the classifier to the standard provided to the classifier by the coater. In this manner, the classifier can determine whether the object the luminescent coating of which is being inquired of is authentic or not.

The method further provides for the coater to change the luminescent coating deposited upon the plurality of objects after some period of time from one particular particulate luminescent composition to another, thereby changing the standard as well. By providing the new standard to the classifier, the coater can then make whatever change desired in the coating of the plurality of objects.

In particular, it is envisioned that the coater may be a manufacturer or distributor of manufactured articles. In order to combat the presence of counterfeit goods in the marketplace, the coater applies a coating comprising a first embodiment of the luminescent chelate composition as described, supra. The coating so formulated is then applied to the manufactured articles for a period of time. After that period of time, which may be of any arbitrary length, the coater changes to a different coating composition comprising a second, and different, luminescent chelate composition. As described supra, the second luminescent chelate composition will exhibit a difference in peak intensity ratios, or, indeed, different intensity peaks altogether, from those of the first luminescent chelate composition. Therefore the standard as defined supra will also be changed from a first standard to a second standard. By informing the classifier of the change in standard, the coater can then readily change from one identifier to a different identifier.

The coater may provide the carrier information concerning the appropriate standard to employ by any means available in the art, both involving the transfer of written documents, or the transmission of electronic signals to an automated detection apparatus.

### EXAMPLES

### Example 1

A. Synthesis of thiophene-2-carboxylic acid (2-dimethylamino-ethyl)-amide

5.31 g of 2-thenoyl chloride (TCI America) was dissolved in 100 ml of anhydrous acetonitrile. 5.51 ml of N,N-dimethylamino-ethane diamine was added in dropwise to the solution so formed. The resulting reaction mixture was stirred for 12 h and then refluxed for 2 h at 82° C. 100 ml of distilled water and 5 ml of concentrated ammonium hydroxide were added along with 100 ml of diethylether in a separatory funnel. The phases were separated and the aqueous phase was washed with 100 ml of dichloromethane. The organic fractions were collected and dried with magnesium sulfate and the solvent was removed under reduced pressure to yield a white solid. Yield 82% (8.12 g; 41.00 mmol)

¹H NMR (CD₃CN): δ 7.56-7.54 (m, 2H), 7.09-7.07 (m, 2H), 3.39 (q, 2H), 2.43 (t, 2H), 2.19 (s 6H).

¹³C NMR (CD₃CN): δ 162.64, 140.97, 131.24, 128.80, 128.61, 59.16, 45.77, 38.47.

B. Synthesis of tris [thiophene-2-carboxylic acid (2-dimethylamino-ethyl)-amidate] europium

In a 250 ml round-bottom Schlenk flask, 25 g of europium (III) trifluoroacetate hydrate (Alfa Aesar) was heated under vacuum (30 mTorr) in a sand bath to 100° C. for a period of 12 h. The flask was back filled with Ar and was stored in an inert atmosphere until further use. The yield after dehydration was quantitative.

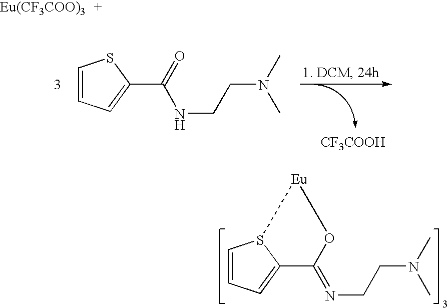

1.473 g of the anhydrous europium (III) trifluoroacetate thus prepared was dissolved in 50 ml of anhydrous dichloromethane. To the solution so formed, 1.785 g of thiophene-2-carboxylic acid (2-dimethylamino-ethyl)-amide was added and the resulting solution was stirred for 24 h. The solvent was removed under reduced pressure and the white solid was washed with anhydrous hexane. The white precipitate was dried to yield 1.84 g (69%; 746.77 g/mol) of final product.

¹H NMR (CD₂Cl₂): δ 7.54 (m, 1H), 7.49 (m, 1H), 7.08 (m, 1H), 3.54 (q, 2H), 2.68 (t, 2H), 2.41 (s, 6H)

¹³C NMR (CD₂Cl₂): δ 162.2, 130.16, 128.17, 127.99, 58.30, 45.02, 36.88.

Elemental Analysis [EuC₂₇H₃₆N₆O₃S₃]: calculated. (found) H 4.89 (4.79), C 43.77 (42.85), N 11.34 (11.11)

C. Synthesis of tris [thiophene-2-carboxylic acid (2-dimethylamino-ethyl)-amidate] bis(triphenylphosphine oxide) europium

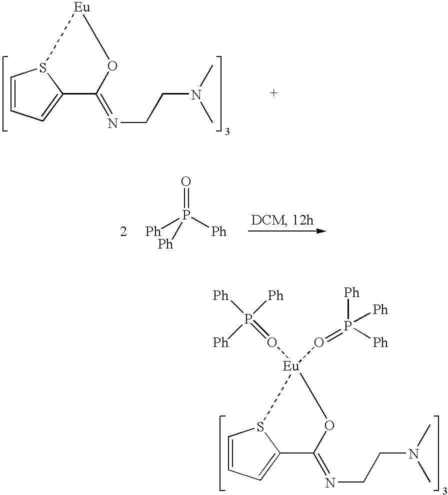

2.24 g (3.0 mmol; 746.77 g/mol) of the Eu[C9H13N2OS]3 of Example 9 was combined with 1.67 g of triphenylphosphine oxide in 25 ml of anhydrous dichloromethane. The solution so formed turned to a clear slightly yellow color upon addition of the triphenylphosphine oxide. The solution was stirred at room temperature for 12 h before removing the solvent under reduced pressure at which point a waxy oil was obtained. The residue was washed with anhydrous hexane and dried under vacuum. Yield 2.85 g (73%).

¹H NMR (CD₂Cl₂): δ 7.62, 7.52, 7.48, 7.44, 7.07, 3.68, 3.64, 2.87, 2.54, 1.81

¹³C NMR (CD₂Cl₂): δ 139.85, 132.24, 130.34, 128.90, 128.60, 128.04, 68.15, 58.38, 44.84, 25.93.

³¹P NMR (CD₂Cl₂): δ 27.71

Elemental Analysis [EuC₆₃H₆₆N₆O₅S₃P₂]: calculated. (found) H 5.13 (5.06), C 58.32 (57.61), N 6.48 (6.40)

### D. Preparation of Coated Article

A 0.2 M solution of tris [thiophene-2-carboxylic acid (2-dimethylamino-ethyl)-amidate] bis(triphenylphosphine oxide) europium was prepared in toluene by dissolving 0.10 g of europium complex in 4 ml of toluene.

The reservoir of a MicroFab Jet Lab II (MicroFab Technologies, Plano, Tex.) ink jet printer was filled with the solution so prepared, and a 1 cm² area was printed on an Avery® 8160 adhesive-back label using a 60 micron diameter nozzle printing tip at a 400 Hz frequency and using the waveform parameters shown in Table 2:

TABLE 2

| | | |
|---|---|---|
| rise | 1 | microsecond |
| dwell | 3 | microseconds |
| fall | 1 | microsecond |
| echo dwell | 3 | microseconds |
| final rise | 1 | microsecond |
| dwell voltage | 43 | V |
| echo voltage | −43 | V |
| frequency | 400 | Hz. |

After drying, the coating so deposited was illuminated at 365 nm using a UV lamp (Entela model UVL-56; 6W, 365 nm wavelength). Pink/red luminescence known to be characteristic of europium (III) was visually observed.

### Example 2

A. Synthesis of tris [thiophene-2-carboxylic acid (2-dimethylamino-ethyl)-amidate] terbium

1.01 g of anhydrous terbium (III) acetate, purchased commercially and dehydrated in the manner of the europium fluoroacetate of Example 1, was dissolved in 50 ml of anhydrous dichloromethane . To this solution, 1.785 g of the thiophene-2-carboxylic acid (2-dimethylamino-ethyl)-amide of Example 1 was added and stirred for 24 h. The solvent was removed under reduced pressure and the white solid was washed with anhydrous hexane. The white precipitate was dried to yield 1.78 g (79%; 750.71 g/mol) of final product.

¹H NMR (CD₂Cl₂): δ 7.54 (m, 1H), 7.49 (m, 1H), 7.08 (m, 1H), 3.54 (q, 2H), 2.68 (t, 2H), 2.41 (s, 6H)

¹³C NMR (CD₂Cl₂): δ 162.2, 130.16, 128.17, 127.99, 58.30, 45.02, 36.88.

Elemental Analysis [TbC₂₇H₃₆N₆O₃S₃]: calculated. (found) H 4.85 (5.00), C 43.37 (42.34), N 11.34 (10.97)

### B. Preparation of Coated Article

A 0.03 M solution of the thus prepared tris [thiophene-2-carboxylic acid (2-dimethylamino-ethyl)-amidate] terbium was prepared in ethylene glycol dimethyl ether by dissolving 0.10 g of terbium complex in 4 ml of ethylene glycol dimethyl ether.

The solution was printed onto an Avery® 8160 adhesive-back label by filling the reservoir of a syringe with the thus prepared solution and then dispensing the solution through the syringe onto the label. After drying, the coating so deposited was illuminated at 365 nm using the Entela UV lamp of Example 1. Green luminescence known to be characteristic of terbium (III) was visually observed.

### Example 3

A. Synthesis of naphthalene-1-carboxylic acid (2-dimethylamino-ethyl)-amide

9.53 g of 1-Naphthyl carbonyl chloride (TCI America) was dissolved in 100 ml of anhydrous acetonitrile and subsequently, 5.51 ml of N,N-dimethylamino-ethane diamine (Sigma-Aldrich) was added dropwise. The reaction was stirred for 12 h and then refluxed for 2 h at 82° C. 100 ml of distilled water and 5 ml of concentrated ammonium hydroxide were added along with 100 ml of diethylether in a separatory funnel. The phases were separated and the aqueous phase was washed with 100 ml of dichloromethane. The organic fractions were then collected and dried with magnesium sulfate and the solvent was removed under reduced pressure to yield a white solid. Yield 10.63 g (43.87 mmol; 88%).

¹H NMR (CD₃CN): δ 8.29-8.27 (m, 1H), 7.93-7.88 (m, 2H), 7.56-7.50 (m, 3H), 7.47-7.44 (m, 1H), 7.03 (br, 1H), 3.46 (q, 2H), 2.46 (t, 2H), 2.21 (s, 6H)

¹³C NMR (CD₃CN): δ 169.89, 136.20, 134.66, 131.13, 130.95, 129.25, 127.74, 127.31, 126.54, 125.98, 125.93, 59.08, 45.75, 38.52

B. Synthesis of tris [naphthalene-1-carboxylic acid (2-dimethylamino-ethyl)-amidate] europium

1.47 g (3 mmol, 490.99 g/mol) of the anhydrous europium (III) trifluoroacetate of Example 1 and 2.18 g of naphthalene-1-carboxylic acid (2-dimethylamino-ethyl)-amide (9 mmol), as prepared supra, were combined in 42 ml of anhydrous dichloromethane. The solution so formed was stirred for 12 h upon which the solvent was removed under reduced pressure to yield a white solid. The white solid was washed with 3×10 ml aliquots of anhydrous diethylether and was then dried under vacuum. Yield 55% (1.44 g; 875.85 g/mol).

¹H NMR (CD₂Cl₂): δ 8.31 (br), 7.90 (d), 7.86 (d), 7.66 (m), 7.52 (m), 7.43 (m), 3.83 (br), 3.19 (br), 2.77 (s), 1.28 (m), 0.89 (t)

¹³C NMR (CD₂Cl₂): δ 134.09. 131.04, 130.59, 128.63, 127,25, 126.66, 125.85, 125.15, 58.40, 44.54, 36.58, 32.25, 29.40, 23.06, 14.26.

Elemental Analysis [EuC₄₅H₅₁N₆O₃]: calculated (found) H 5.86 (5.97), C 61.71 (60.46), N 9.59 (9.40)

### C. Preparation of Coated Article

A 0.03 M solution of the thus prepared tris [naphthalene-1-carboxylic acid (2-dimethylamino-ethyl)-amidate] europium was prepared in ethylene glycol dimethyl ether by dissolving 0.10 g of the europium complex in 4 ml of ethylene glycol dimethyl ether. The solution was printed in the manner of Example 2 onto an Avery® 8160 adhesive-back label. After drying, the coating so deposited was illuminated at 365 nm using a the Entela UV lamp of Example 1. Pink/red luminescence known to be characteristic of europium (III) was visually observed.

What is claimed is:

1. A method comprising exposing at least a portion of a luminescent coating disposed on a surface of an article to ultraviolet light causing the luminescent coating to exhibit luminescence, detecting the luminescence, causing a comparison to be made between the luminescence and a predetermined standard, and classifying the article according to the comparison, wherein the luminescent coating comprises a luminescent chelate comprising a lanthanide and a ligand, the ligand being represented by the formula 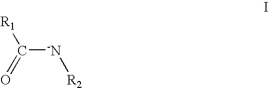
wherein R₁ is alkyl, aryl, or heteroaryl; R₂ is alkyl, aminoalkyl; aryl or heteroaryl.

2. A method comprising within a first time period, disposing upon at least a portion of a surface of a first article a first luminescent coating wherein the first luminescent coating comprises a first luminescent chelate comprising a lanthanide and a ligand, the ligand being represented by the formula 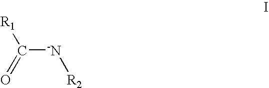
wherein R₁ is alkyl, aryl, or heteroaryl; R₂ is alkyl, aminoalkyl; aryl or heteroaryl; optionally, drying the coating; and, exposing the first coating to a first preselected wavelength of light wherein the first luminescent chelate exhibits a first luminescence spectrum having a first plurality of intensity peaks.

3. The method of claim 2 further comprising within a second time period, disposing upon at least a portion of the surface of a second article a second luminescent coating wherein the second coating comprises a second luminescent chelate comprising a lanthanide and a ligand, the ligand being represented by the formula 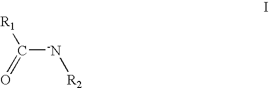
wherein R₁ is alkyl, aryl, or heteroaryl; R₂ is alkyl, aminoalkyl; aryl or heteroaryl; optionally, drying the second coating; and, exposing the second coating to a second preselected wavelength of light wherein the second luminescent chelate exhibits a second luminescence spectrum having a second plurality of intensity peaks with the proviso that the first luminescent chelate is different from the second luminescent chelate.

4. The method of claim 2 further comprising comparing the first plurality of intensity peaks to a first standard, and classifying the article according to whether or not the peak intensity ratio does or does not match the standard.

5. The method of claim 3 further comprising comparing the second plurality of intensity peaks to a second standard, and classifying the article according to whether or not the peak intensity ratio does or does not match the standard.

6. The method of claims 4 or 5 wherein the standard includes information regarding a preselected exposure wavelength and a plurality of preselected luminescence wavelength peaks, and a peak intensity ratio thereof.

7. The method of claims 1, 2 or 3 wherein the lanthanide is selected from the group consisting of Eu³⁺, Tb³⁺, Sm³⁺, and Dy³⁺.

8. The method of claims 1, 2 or 3 wherein R₁ and R₂ are each independently selected from phenyl, napthyl, anthracyl, phenanthrenyl thiophenyl, pyridinyl, furanyl, or dialkylaminoethyl.

9. The method of claim 8 wherein R₂ is dimethylaminoethyl.

10. The method of claim 1, 2 or 3 wherein the chelate further comprises a neutrally charged coordinating ligand.

11. The method of claim 10 wherein the neutrally charged coordinating ligand is pyridine, pyridine-N-oxide, thiophene, furane, ketones, 1,10-phenathroline, aryl, C1-C6 alkyl-tri-substituted phosphine oxides or disubstituted-1,2-ethyldiphosphine oxide

12. The method of claims 1, 2 or 3 wherein the coating further comprises a polymer.

13. The method of claim 1, 2 or 3 wherein the chelate is a coordination compound represented by the structure 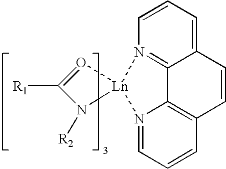
wherein Ln is Eu³⁺, Tb⁺³, Sm⁺³, or Dy⁺³; R₁ is phenyl, naphthyl, thiophenyl, furanyl, pyridyl, C1 to C6 alkyl, anthrancenyl, or phenanthracenyl; and R₂ is phenyl, naphthyl, pyridyl, C1 to C6 alkyl, anthrancenyl, phenanthracenyl, or dimethylaminoethyl.

14. The method of claim 1, 2 or 3 wherein the lanthanide chelate is a coordination compound represented by the structure 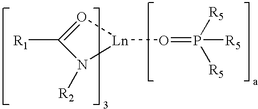
wherein a=1 or 2, Ln is Eu³⁺, Tb³⁺, Sm³⁺, or Dy³⁺; R₁ is phenyl, naphthyl, thiophenyl, furanyl, pyridyl, C1 to C6 alkyl, anthrancenyl, or phenanthracenyl; R₂ is phenyl, naphthyl, pyridyl, C1 to C6 alkyl, anthrancenyl, phenanthracenyl, or dimethylaminoethyl, and R₅ is aryl or C1 to C6 alkyl.

15. The method of claim 14 wherein R₁ is thiophenyl or naphthyl;
and R₂ is dimethylaminoethyl; and R₅ is phenyl.
